(19) United States
(12) Patent Application Publication
(10) Pub. No.: US 2024/0054346 A1
(43) Pub. Date: Feb. 15, 2024

(54) SYSTEMS AND METHODS FOR SIMULTANEOUS NETWORK PRUNING AND PARAMETER OPTIMIZATION

(71) Applicant: JPMORGAN CHASE BANK, N.A., New York, NY (US)

(72) Inventors: Xiaoying ZHI, Zurich (CH); Sean MORAN, London (GB); Fanny SILAVONG, London (GB); Ruibo SHI, London (GB); Pheobe SUN, London (GB)

(21) Appl. No.: 18/358,629

(22) Filed: Jul. 25, 2023

Related U.S. Application Data
(60) Provisional application No. 63/371,299, filed on Aug. 12, 2022.

(51) Int. Cl. G06N 3/082; G06N 3/084

(52) U.S. Cl. CPC G06N 3/082; G06N 3/084

(57) ABSTRACT

Systems and methods for simultaneous network pruning and parameter optimization are disclosed. A method may include: (1) receiving a network to optimize, the network comprising a plurality of layers; (2) selecting layer pruning and/or channel pruning for the layers within the network; (3) providing a gating module at layers within the network, wherein each gating module opens or closes a gate in the gating module based on an output of a binary head; (4) training parameters for the network; (5) extracting gate open/close features from the gating modules; (6) optimizing a loss function for the network using a polarization regularizer to reach a consensus static sub-network; and (7) updating parameters for each gating module in the network consistent with the consensus static sub-network.

### RELATED APPLICATIONS

This application claims priority to, and the benefit of, U.S. Provisional Patent Application Ser. No. 63/371,299, filed Aug. 12, 2023, the disclosure of which is hereby incorporated, by reference, in its entirety.

### BACKGROUND OF THE INVENTION

### 1. Field of the Invention

Embodiments relate generally to systems and methods for simultaneous network pruning and parameter optimization.

### 2. Description of the Related Art

Sparse and over-parameterized neural networks achieve state-of-the-art performance but expend an excessive amount of energy during training and inference. Some large models have billions of parameters; the training time can take up to hundreds of Graphical Processing Unit (GPU)/Tensor Processing Unit (TPU) days, which equates to several times the annual total energy consumption of a standard household. Existing solutions to reduce the computational burden usually involve pruning the network parameters.

In general, the greater the degrees of freedom (i.e., the parameters) in the neural network, the better the performance. This, however, comes with two sacrifices—an increased risk of overfitting and an increase in the number of computations (and hence energy usage) needed for training and inference.

Network pruning is based on the assumption that over-parameterized networks can safely remove parameters before or after training. A pruned network is valid if the removed parameters can be predicted and the performances of the pruned network can be kept the same. There are two common types of network pruning methods—static and dynamic. Static network pruning often involves a pre-defined neuron importance measure that determines which trained neurons should not be pruned. Dynamic pruning, on the other hand, applies a parameterized or a learnable gating function that computes the neuron importance on the fly, leading to a different computational graph for each data sample, both at the training and the inference phases.

From a green Artificial Intelligence (AI) perspective, neither of the existing approaches are ideal. The dynamic pruning approach is not optimal for parallel computing due to limitations on speed and costly computations. The necessity to index each input sample at inference phase limits the speed, and an extra round of neuron importance computation wastes computational resources. The static network pruning method can reduce computational resources at the inference phase, but the iterative pruning-and-fine-tuning procedure consumes more computational resources during the training phases and takes longer training time. One-shot pruning is no better than the iterative procedure as its effectiveness heavily depends on the assumed priors which lacks verification in their validity.

### SUMMARY OF THE INVENTION

Systems and methods for simultaneous network pruning and parameter optimization are disclosed. According to one embodiment, a method for network pruning may include: (1) receiving, by a network optimization computer program, a network to optimize, the network comprising a plurality of layers; (2) selecting, by the network optimization computer program, layer pruning and/or channel pruning for the layers within the network; (3) providing, by the network optimization computer program, a gating module at layers within the network, wherein each gating module opens or closes a gate in the gating module based on an output of a binary head; (4) training, by the network optimization computer program, parameters for the network; (5) extracting, by the network optimization computer program, gate open/close features from the gating modules; (6) optimizing, by the network optimization computer program, a loss function for the network, wherein the network optimization computer program uses a polarization regularizer to reach a consensus static sub-network; and (7) updating, by the network optimization computer program, parameters for each gating module in the network consistent with the consensus static sub-network.

In one embodiment, the gating modules may include a channel pruning gating module and/or a layer pruning gating module.

In one embodiment, the network may include a residual network.

In one embodiment, the network may include a sequential network.

In one embodiment, the method may also include receiving, by the network optimization computer program, a sparsity hyperparameter.

In one embodiment, the gating modules may be added at a beginning of each layer and each channel within the network.

In one embodiment, each gating module may include a fully connected layer and a binary head, wherein the fully connected layer that receives a one-dimensional vector, multiplies the one-dimensional vector by a weight matrices, and outputs an output vector, and the binary head receives the output vector and returns a binary value indicating whether the layer will be computed.

In one embodiment, the binary head may include a straight-through estimator. A gradient of the straight-through estimator may update the parameters of the gating modules through back propagation. The parameters may include weight matrices.

According to another embodiment, a non-transitory computer readable storage medium may include instructions stored thereon, which when read and executed by one or more computer processors, cause the one or more computer processors to perform steps comprising: receiving a network to optimize, the network comprising a plurality of layers; selecting layer pruning and/or channel pruning for the layers within the network; providing a gating module at layers within the network, wherein each gating module opens or closes a gate in the gating module based on an output of a binary head; training parameters for the network; extracting gate open/close features from the gating modules; optimizing a loss function for the network using a polarization regularizer to reach a consensus static sub-network; and updating parameters for each gating module in the network consistent with the consensus static sub-network.

In one embodiment, the gating modules may include a channel pruning gating module and/or a layer pruning gating module.

In one embodiment, the network may include a residual network.

In one embodiment, the network may include a sequential network.

In one embodiment, the non-transitory computer readable storage medium may also include instructions stored thereon, which when read and executed by one or more computer processors, cause the one or more computer processors to receive a sparsity hyperparameter.

In one embodiment, the gating modules may be added at a beginning of each layer and each channel within the network.

In one embodiment, each gating module may include a fully connected layer and a binary head, wherein the fully connected layer that receives a one-dimensional vector, multiplies the one-dimensional vector by a weight matrices, and outputs an output vector, and the binary head receives the output vector and returns a binary value indicating whether the layer will be computed.

In one embodiment, the binary head may include a straight-through estimator. A gradient of the straight-through estimator may update the parameters of the gating modules through back propagation. The parameters may include weight matrices.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1A depicts a neural network with layer-pruning gating module according to an embodiment;

FIG. 1B depicts a network with channel-pruning gating module according to an embodiment;

FIG. 2 depicts a system for simultaneous network pruning and parameter optimization according to embodiments;

FIG. 3 depicts a method for simultaneous network pruning and parameter optimization according to embodiments;

FIGS. 4A, 4B, 4C, and 4D depict an exemplary implementation of the method of FIG. 3; and

FIG. 5 depicts an exemplary computing system for implementing aspects of the present disclosure.

### DETAILED DESCRIPTION OF PREFERRED EMBODIMENTS

Artificial intelligence (AI) networks may be categorized as Green AI or Red AI based on their carbon emission and electricity usage, elapsed time, parameter count, and floating point operations (FPOs/FLOPs). Embodiments disclosed herein relate generally to making AI networks more green using simultaneous network pruning and parameter optimization. Embodiments may apply to any sequential network, i.e., networks without recurrent mechanisms. Examples of sequential networks include convolutional neural networks, transformers, etc.

Embodiments may be implemented in Residual Networks, or “ResNets.” A ResNet is a type of deep neural network architecture that has become popular in the field of computer vision. It is designed to help address the challenge of training very deep neural networks effectively. Instead of trying to directly learn the mapping from the input to the output at each layer, ResNets introduce shortcuts or “skip connections” between layers. These connections allow information to bypass certain layers and jump directly to deeper layers. These skip connections enable the network to learn residual functions, hence the name “Residual Network.” Each layer can learn to represent the difference (i.e., the residual) between the input and the desired output. By using these residual functions, the network can effectively learn the underlying patterns in the data, even in very deep architectures.

Embodiments may use a light-weight neuron gating layer and a special regularization term with no extra procedures in network training and inference.

Embodiments may implement a parameter pruning process that identifies a group of lightweight sub-networks that achieve similar effectiveness of a large network on a given downstream task. Embodiments may only require a once-off training to discover the static sub-networks by using dynamic pruning methods. The sub-network pruning scheme may include a light-weight, differentiable, and binarized gating module and a novel polarization regularizer. With this, a myriad of possible dynamic architectures may be unified to a single solution. Embodiments may also enable pruning and training simultaneously, which saves energy in both training and inference phases and avoids extra computational overhead from the gating modules at inference time.

Embodiments may provide at least some of the following technical advantages: simultaneous network pruning and optimization; no need to fine tune the sub-network; ready-to-use smaller network at inference; optimal for batch processors (GPU/TPU); and generalizable to various types of sequential networks.

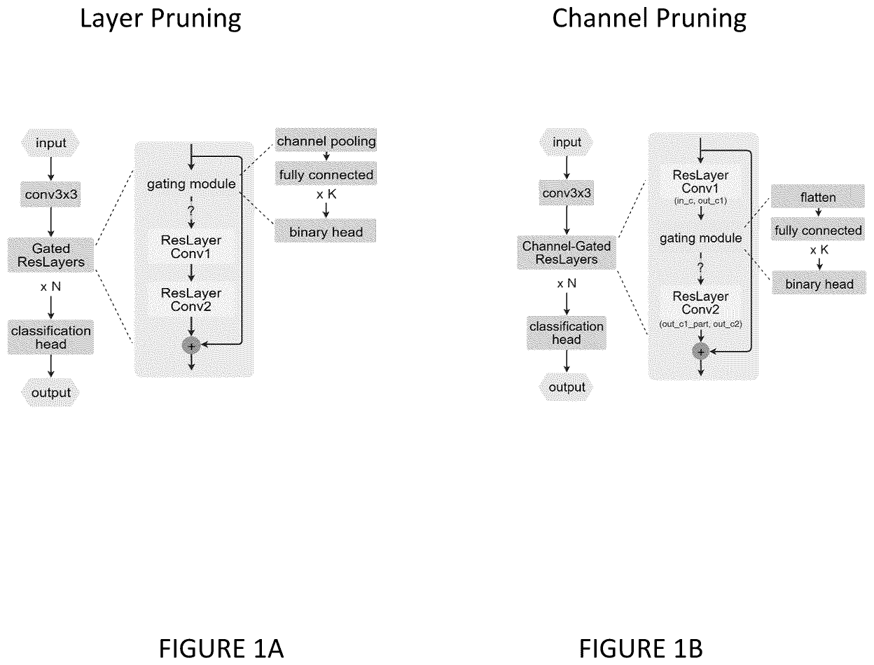

FIG. 1A depicts a network with a layer-pruning gating module in a ResNet according to an embodiment. For example, a layer-pruning gating module may be placed in front of each residual layer, including two or three convolutional layers, depending on the basic residual block.

FIG. 1B depicts a network with channel-pruning gating module according to an embodiment. The channel-pruning gating module may be placed in between connecting convolutional layers in the same residual layer. The gating module may be placed in-between connecting convolutional layers in the same residual layer. A residual layer can thus have one channel gating module if it is of the basic block structure, and two channel gating modules if there is a bottleneck.

A fully connected layer takes as input a one-dimensional vector, multiplies it with a corresponding series of weight matrices, and returns an output vector, which may be a different sized vector, a number (i.e., a size 1 vector), etc.

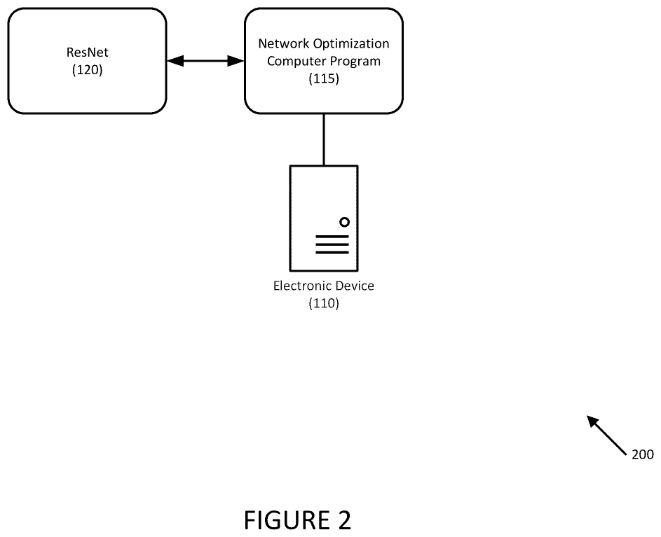

The binary head may take, as an input, the output of the previous fully connected layer and may return a number {0,1}, where 0 means no further computation will be performed in the particular layer or channel. In FIG. 1A, if the binary head has a value of 0, ResLayer Conv1 and ResLayer Conv2 are bypassed, thereby saving computation. Similarly in FIG. 2A, if the binary head has an output of 0, ResLayer Conv2 is bypassed.

Conversely, if a binary head returns 1, the ResLayers are not bypassed and computation proceeds as normal.

In layer pruning, a gating module may be added at the beginning of each residual layer to decide whether that layer is to be computed or not. If the gate is closed (i.e., the binary head returns 0), the entire input (of shape Channels×Width×Height) is passed to the next layer without any computation. Of course, if the gate is open (i.e., the binary head returns 1), the layer is computed.

The channel pruning method is a generalization of the layer pruning method. In the channel pruning method, the gating module can be placed anywhere in a layer. In addition, there is flexibility in placing the gating modules at each channel (where the input is of shape Channels×Width×Height), so computation (e.g., ResLayer Conv2 is only performed for specific channels while other channels will pass through undisturbed).

The classification head may include a fully connected layer that flattens the multidimensional (i.e., Channels×Width×Height) output of the previous layers into a one-dimensional vector, multiplies it by a weight matrix, and outputs a probability distribution over the possible classes (e.g., is this image a car, dog, cat, etc?). The output from the ResLayer Conv2 may be an intermediate tensor of shape (i.e., Channels×Width×Height) that may either be passed to the classification head or to additional similar layers in FIG. 1A, 1B.

In embodiments, the training and testing steps—defining a loss function, using gradient descent to update the network parameters, etc.—may be the same as with most neural networks. A polarization regularizer may be provided as a controller to encourage the outputs of gating modules of a specific connection (e.g., a layer, a channel, etc.) for all input samples to be the same.

Embodiments may use a straight-through estimator, or STE, as the binary head for the gating module, where x is the input to the STE function. The forward path of the STE is a hard thresholding function:

$$STE ( x ) = \{ \begin{matrix}1 , & if x > 0 \\ 0 , & if x \leq 0\end{matrix}$$

STE is lightweight for both forward and backward propagation. In the forward path, no other computations than a sign checker is needed. In the backward path, there is not even any computation needed. The gradient estimation, often viewed as a coarse approximation of the true gradient under noise, has been proven to positively correlate with the population gradient, thus gradient descent on which helps to minimize the empirical loss.

Because the STE is a hard thresholding function, it is not immediately differentiable. The gradient of this function may be approximated using the following equation without loss in performance:

$$\frac{\partial ℒ}{\partial x} = \frac{\partial ℒ}{\partial STE ( x )} \cdot \frac{\partial STE ( x )}{\partial x} = \{ \begin{matrix}\frac{\partial ℒ}{\partial STE ( x )} , & if \vert x \vert \leq 1 \\ 0 , & if \vert x \vert > 1\end{matrix}$$

The gradient of the STE may be used to update the weight matrices in the entire network. The STE gradient may be passed on through all the different layers (e.g., fully connected, residual, etc.) through a series of gradient multiplications (i.e., back propagation). Thus, the weight matrices of all layers may be moved in the direction so as to minimize the error of the model and maintain sparsity.

FIG. 2 depicts a system for simultaneous network pruning and parameter optimization according to embodiments. System 100 may include electronic device 110, which may be a server (e.g., physical and/or cloud-based), a computer (e.g., a workstation, a desktop, a laptop, a notebook, a tablet, etc.), a smart device (e.g., a smart phone, a smart watch, etc.), an Internet of Things (IoT) appliance, etc. Electronic device 110 may execute network optimization computer program 115 that may receive or access ResNet 120 and may optimize ResNet 120.

ResNet 120 may be trained on any suitable electronic device, including servers, the cloud, etc.

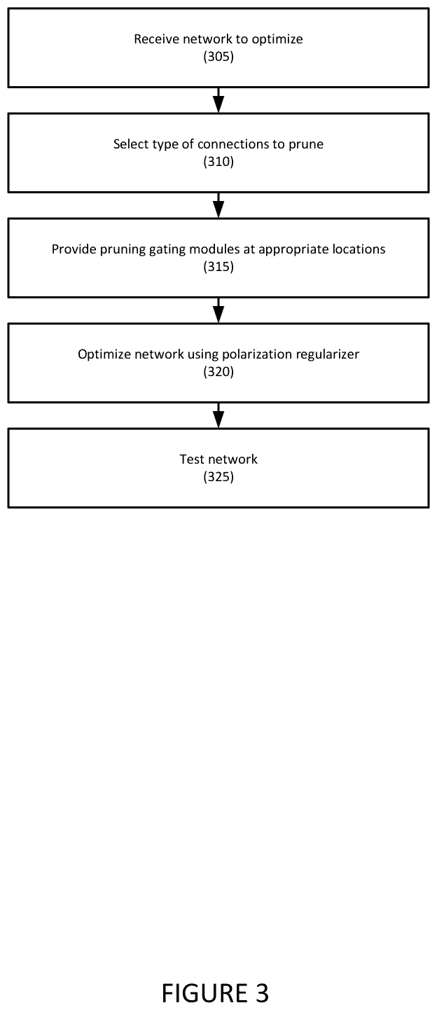

FIG. 3 depicts a method for simultaneous network pruning and parameter optimization according to embodiments.

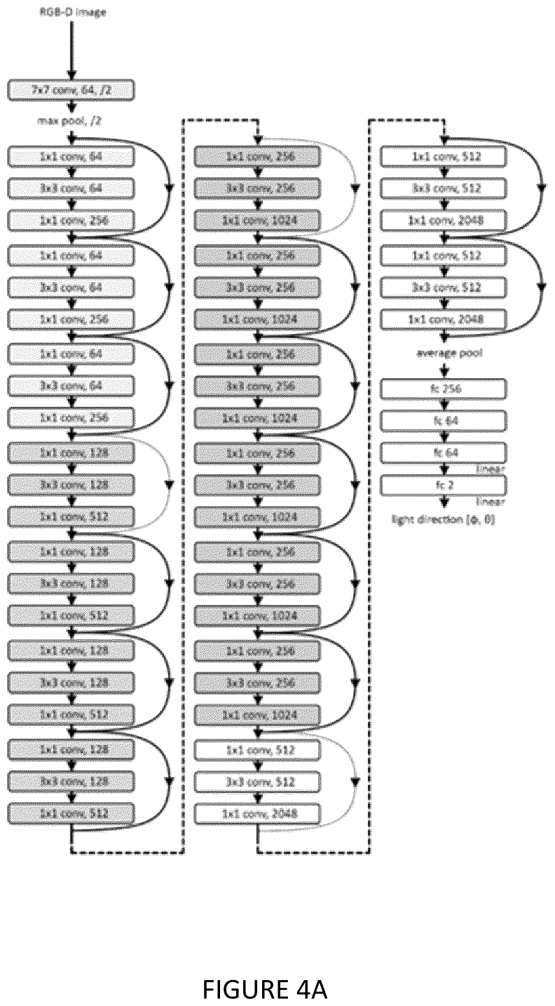

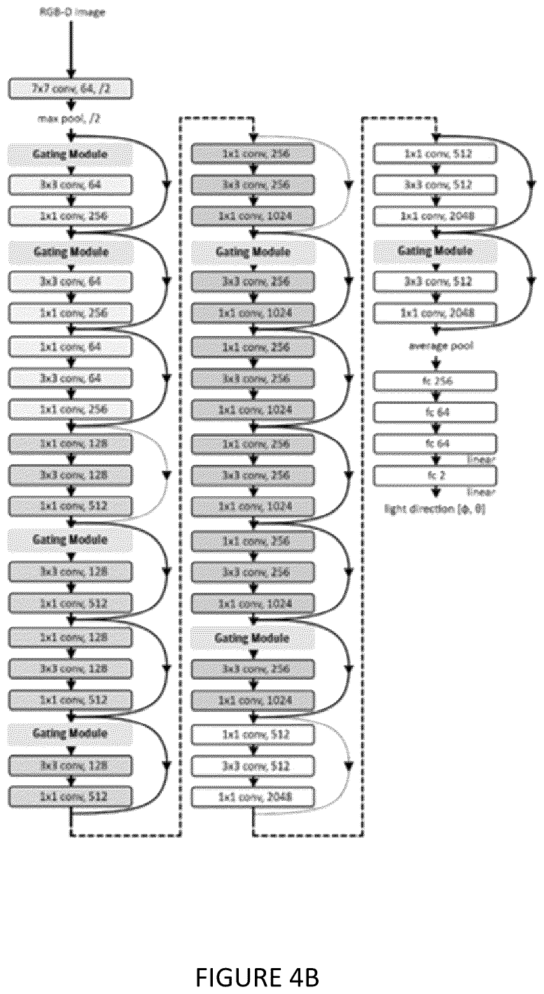

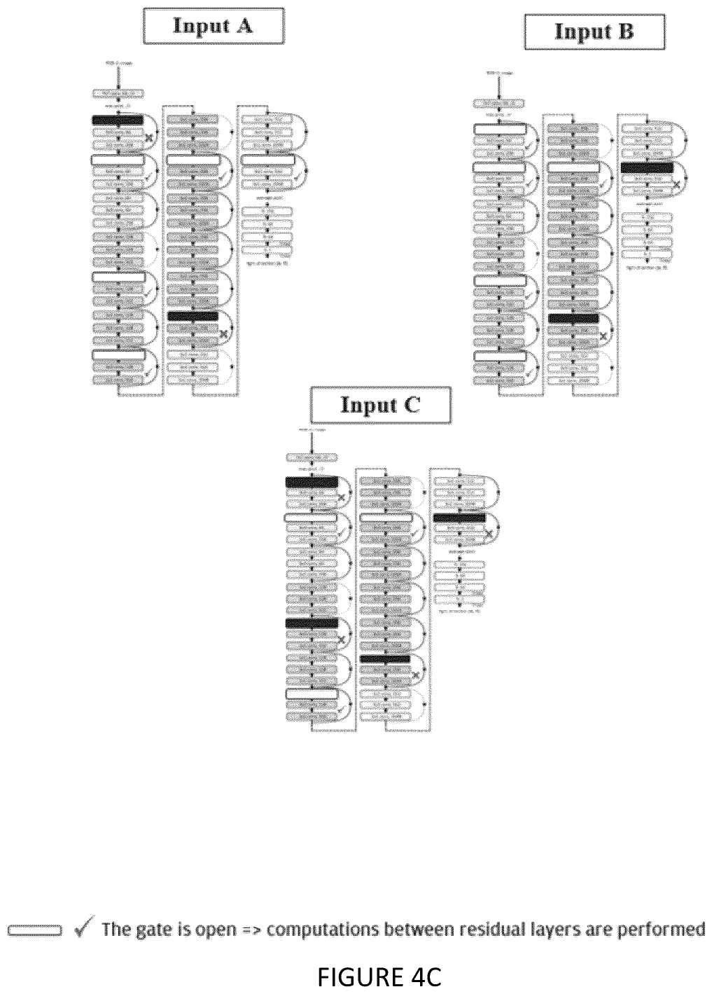

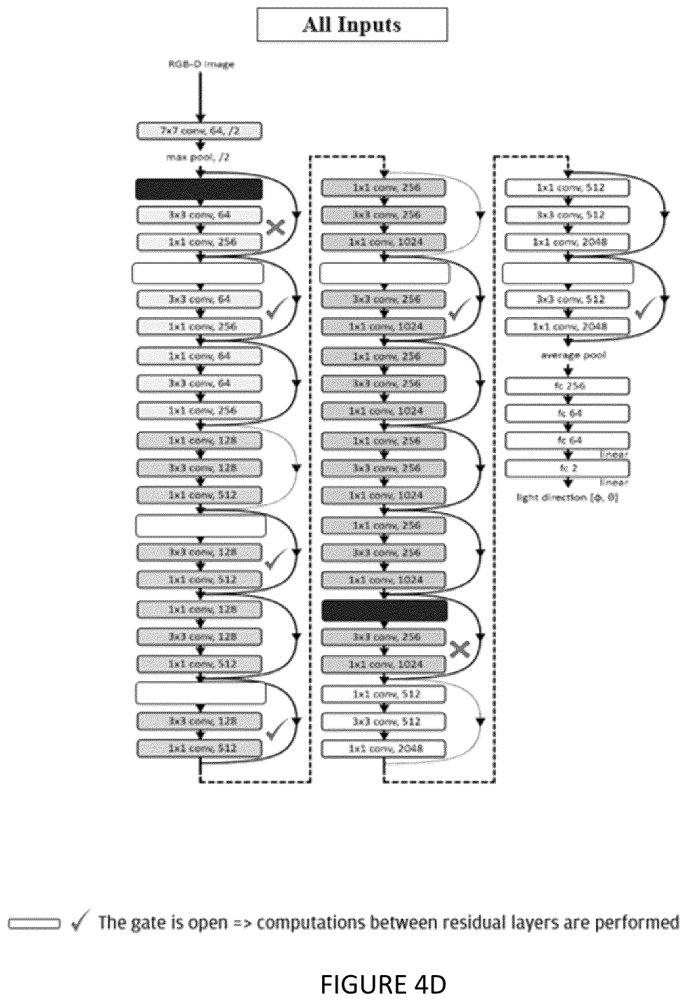

In step 305, a network optimization computer program may receive network to optimize. For example, the network to be optimized may be a ResNet. An example of such a ResNet network is illustrated in FIG. 4A.

In one embodiment, the user may specify a sparsity level as a hyperparameter. The sparsity level modifies the loss function. The higher the level of sparsity desired, the more the number of gating modules that will be closed.

In step 310, the network optimization computer program may select the type of connections to prune. For example, all layers, selected layers, all channels, specific channels, all connections, specific connections, combinations thereof, etc. may be selected for pruning.

In one embodiment, the types of connections to prune may be specified by the user.

In step 315, the network optimization computer program may provide a layer pruning gating module and/or a channel pruning gating module in the network at the appropriate location for the type of pruning. The layer pruning gating modules or the channel pruning gating modules may be added to any desired residual location in the network. For example, gating modules may be placed, for example, at the beginning of every layer and in every channel. Depending on the pruning rate (i.e., sparsity) that is specified as a hyperparameter, the network may learn which gating modules to keep open and which ones to close. This may be done through backpropagation, where the gradient of the gating module with respect to the objective function provides a signal for updating the weights of the network.

An example of adding a layer pruning gating module or a channel pruning gating module is illustrated in FIG. 4B. As illustrated in FIG. 2, gating modules have been added at several locations within the residual network.

In step 320, the network may be pruned and optimized and the parameters may be trained. For example, the fully connected layers in the gating module may extract features for gate open/close binary classification. The binary head in the gating module provides the gate open/close binary classification.

In one embodiment, the network parameters and gating modules may be optimized for accuracy by optimizing the loss function:

[symbol]

(ƒ(x),y)= [symbol] ₜₐₛₖ(ƒ(x),y)+λ [symbol] ₚₒₗₐᵣ(Wₑ(x))

where Ltask is the task loss, e.g., the cross-entropy loss for classification tasks and mean-squared error for regression tasks, and Rpolar is a polarization regularizer.

The polarization regularizer encourages a “consensus” static sub-network to appear at the end of training and that has good performance for all data-points.

An example of training is illustrated in FIG. 4C.

In step 325, the network may be tested. For example, when gates are open, computations between residual layers are performed. When gates are closed, computations between residual layers are not performed.

An example of testing is illustrated in FIG. 4D.

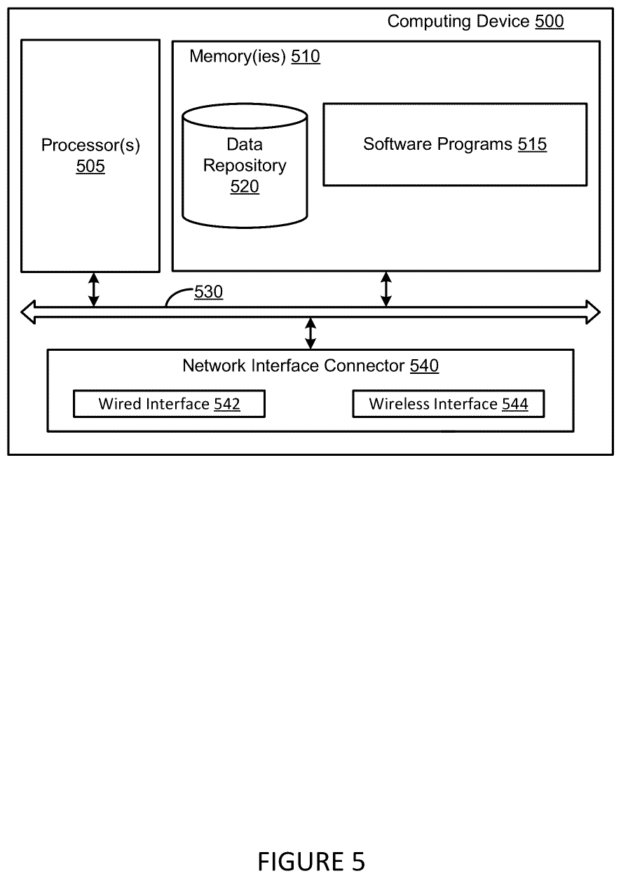

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for network pruning, comprising:
receiving, by a network optimization computer program, a network to optimize, the network comprising a plurality of layers;
selecting, by the network optimization computer program, layer pruning and/or channel pruning for the layers within the network;
providing, by the network optimization computer program, a gating module at layers within the network, wherein each gating module opens or closes a gate in the gating module based on an output of a binary head;
training, by the network optimization computer program, parameters for the network;
extracting, by the network optimization computer program, gate open/close features from the gating modules;
optimizing, by the network optimization computer program, a loss function for the network, wherein the network optimization computer program uses a polarization regularizer to reach a consensus static sub-network; and
updating, by the network optimization computer program, parameters for each gating module in the network consistent with the consensus static sub-network.

2. The method of claim 1, wherein the gating modules comprise a channel pruning gating module and/or a layer pruning gating module.

3. The method of claim 1, wherein the network comprises a residual network.

4. The method of claim 1, wherein the network comprises a sequential network.

5. The method of claim 1, further comprising:
receiving, by the network optimization computer program, a sparsity hyperparameter.

6. The method of claim 1, wherein the gating modules are added at a beginning of each layer and each channel within the network.

7. The method of claim 1, wherein each gating module comprises a fully connected layer and a binary head, wherein the fully connected layer that receives a one-dimensional vector, multiplies the one-dimensional vector by a weight matrices, and outputs an output vector, and the binary head receives the output vector and returns a binary value indicating whether the layer will be computed.

8. The method of claim 7, wherein the binary head comprises a straight-through estimator.

9. The method of claim 8, wherein a gradient of the straight-through estimator updates the parameters of the gating modules through back propagation.

10. The method of claim 9, wherein the parameters comprise weight matrices.

11. A non-transitory computer readable storage medium, including instructions stored thereon, which when read and executed by one or more computer processors, cause the one or more computer processors to perform steps comprising:
receiving a network to optimize, the network comprising a plurality of layers;
selecting layer pruning and/or channel pruning for the layers within the network;
providing a gating module at layers within the network, wherein each gating module opens or closes a gate in the gating module based on an output of a binary head;
training parameters for the network;
extracting gate open/close features from the gating modules;
optimizing a loss function for the network using a polarization regularizer to reach a consensus static sub-network; and
updating parameters for each gating module in the network consistent with the consensus static sub-network.

12. The non-transitory computer readable storage medium of claim 11, wherein the gating modules comprise a channel pruning gating module and/or a layer pruning gating module.

13. The non-transitory computer readable storage medium of claim 11, wherein the network comprises a residual network.

14. The non-transitory computer readable storage medium of claim 11, wherein the network comprises a sequential network.

15. The non-transitory computer readable storage medium of claim 11, further comprising instructions stored thereon, which when read and executed by one or more computer processors, cause the one or more computer processors to receive a sparsity hyperparameter.

16. The non-transitory computer readable storage medium of claim 11, wherein the gating modules are added a beginning of each layer and each channel within the network.

17. The non-transitory computer readable storage medium of claim 11, wherein each gating module comprises a fully connected layer and a binary head, wherein the fully connected layer that receives a one-dimensional vector, multiplies the one-dimensional vector by a weight matrices, and outputs an output vector, and the binary head receives the output vector and returns a binary value indicating whether the layer will be computed.

18. The non-transitory computer readable storage medium of claim 17, wherein the binary head comprises a straight-through estimator.

19. The non-transitory computer readable storage medium of claim 18, wherein a gradient of the straight-through estimator updates the parameters of the gating modules through back propagation.

20. The non-transitory computer readable storage medium of claim 19, wherein the parameters comprise weight matrices.
